(19) United States
(12) Patent Application Publication
(10) Pub. No.: US 2026/0048521 A1
(43) Pub. Date: Feb. 19, 2026

(54) BLADE FOR AN OSCILLATING MULTI-TOOL

(71) Applicant: MultiTool Lab Limited, Harrogate (GB)

(72) Inventor: Shane Monaghan, Harrogate (GB)

(21) Appl. No.: 18/678,854

(22) PCT Filed: Nov. 28, 2022
(86) PCT No.: PCT/GB2022/053004

§ 371 Date: May 30, 2024

Related U.S. Application Data
(60) Provisional application No. 63/289,925, filed on Dec. 15, 2021.
(60) Provisional application No. 63/265,699, filed on Dec. 19, 2021.

(30) Foreign Application Priority Data
Dec. 3, 2021 (GB) 2117555.9

(51) Int. Cl. B26D 1/00; B26D 1/30; B26D 7/26

(52) U.S. Cl. CPC B26D 1/0006; B26D 1/30; B26D 7/2614; B26D 2001/0053

(57) ABSTRACT

A blade for an oscillating multi-tool is described. The blade has multiple snap-off sections which can be removed to reveal a new serrated cutting edge. At least one line of cutouts is provided along the width of the blade section, behind a serrated front edge, each cutout defining at least one substantially forward-facing point, and the cutouts are spaced apart along the width of the blade section, a front part of the blade section forward of the cutouts being attached a rear part of the blade section behind the cutouts at least by material in the spaces laterally between the cutouts.

### PRIORITY CLAIM

This application claims priority to International Application No. PCT/GB2022/053004 filed on Nov. 28, 2022, which claims the benefit of GB Application No. 2117555.9 filed on Dec. 3, 2021, U.S. Provisional Ser. No. 63/265,699 filed on Dec. 19, 2021, and U.S. Provisional Ser. No. 63/289,925 filed on Dec. 15, 2021, all of which are incorporated herein by reference.

### TECHNICAL FIELD

The following discussion relates to a blade for an oscillating cutting tool, in particular a blade with multiple cutting edges whereby a worn / blunt cutting edge can be snapped off to reveal a new cutting edge.

### BACKGROUND

Oscillating cutters or multi-tools are very useful in a variety of applications such as fine detailed cutting of, for example, wood, vinyl tiles, and other building components which need to be cut to match a detailed profile to butt against a skirting or architrave, to provide just a few examples.

A variety of different blade shapes are available for these tools. Often, the blade is detachable from the tool typically using a single-lever “quick release” mechanism. A blade can be removed and replaced when it is worn out, or when a different shape of blade is required.

Blades will inevitably wear and become blunt with use. A worn blade will be thrown away, and although it might be recycled, a lot of material and cost is wasted. Typically the blade assembly is in two parts—an attachment section which includes an attachment formation to mate with the oscillating tool, and a blade section which includes the cutting blade. The two parts are welded together and when the blade section is worn, the whole assembly is discarded.

It is therefore desirable to provide a blade assembly for an oscillating tool which can be used for a longer time, thereby reducing waste.

### BRIEF SUMMARY

According to one embodiment, there is provided a blade assembly for an oscillating tool, the blade assembly including: an attachment section having an attachment formation for mating with an oscillating tool; and a blade section, the blade section having a serrated front edge, in which at least one line of cutouts is provided along the width of the blade section, behind the serrated front edge, each cutout defining at least one substantially forward-facing point, and in which the cutouts are spaced apart along the width of the blade section, a front part of the blade section forward of the cutouts being attached to a rear part of the blade section behind the cutouts at least by material in the spaces laterally between the cutouts.

In a further embodiment, the blade assembly has a serrated front edge for use in cutting. After a period of use, the serrated front edge will become worn / blunt. At that point, a front part of the blade section can be snapped off. A new serrated edge will then be revealed at what is then the front of a slightly shorter blade section. The forward-facing points along the line of cutouts form the new serrated edge.

In some examples, one of the cutouts extends to a lateral edge of the blade section and another one of the cutouts extends to the other lateral edge of the blade section. In other words, at each the extreme lateral edge of the blade section, there is a cutout and not a space where the front and rear parts are attached. This ensures that the new serrated edge revealed when the front section is snapped off can cut all the way to its edge, enabling use for detailed cutting work. If desired, each extreme lateral edge of the blade section may come to a point.

In another example, each cutout may be substantially V-shaped, with the point of the V facing forwards. The V-shaped cutouts are provided next to each other, along the line, with the front and rear parts of the blade section being attached between the cutouts (i.e. in a line between the top, rearward, “blunt”, ends of the Vs).

In some embodiments the cutouts, or some of the cutouts, may define a rearward-facing point between two forward-facing points. In other words, the cutouts may be substantially W-shaped, with the two points at the bottom of the W facing forwards. This may improve cutting performance for some materials and applications.

Different designs of serrations are useful to effectively cut through different materials, i.e. metal, dry wood, green wood, plastics, etc.

The cutouts may be through cutouts, i.e. where the blade section is cut all the way through the material. Alternatively the cutouts may be partial cutouts, i.e. where the blade section is thinned so that it will break along the cutout when snapped. The spaces between the cutouts may be continuous, uncut material, or in some embodiments the spaces between the cutouts may be thinned material, but still attached.

The cutouts may be created for example by laser cutting or by stamping. The blade section may be made for example from carbide steel. The cutouts can be bevelled to create a sharper serrated edge.

In some embodiments, there are multiple lines of cutouts spaced along the length of the blade section. For example, there could be ten lines of cutouts, each one spaced behind the other along the length of the blade section. This provides eleven serrated edges (including the serrated edge which is at the front before anything is snapped off) and therefore a blade which can last eleven times longer than a standard blade with the same characteristics, though using only minimal extra material (the blade section may be slightly longer than a standard blade to allow space for all the lines of cutouts, but nevertheless the total amount of material used is likely to be for example less than twice as much material, for a blade which lasts eleven times as long).

A tool may be provided for snapping off a worn edge along the next cutout. The tool may comprise a body having a slit therein for receiving a front edge of the blade section of the blade assembly. The depth of the slit is preferably just less than the space between lines of cutouts along the length of the blade. The tool helps to ensure that the blade snaps only along the next line of cutouts so that serrated edges are not wasted by snapping off two at once.

These and other example embodiments are described in increasing detail below.

### BRIEF DESCRIPTION OF THE DRAWINGS

For a better understanding of the present disclosure and to show more clearly how it may be carried into effect, reference will now be made by way of example only to the accompanying drawings, in which:

FIG. 1 is a side view of a blade according to one embodiment;

FIG. 2 is a view from above of the blade of FIG. 1;

FIG. 3 is a detail from a view from above of the blade of FIG. 1;

FIG. 4 is a detail of an alternative embodiment of a blade; and

FIG. 5 is a detail of the blade of FIG. 1, when a front part of the blade section has been removed from a rear part of the blade section.

### DESCRIPTION OF EXAMPLE EMBODIMENTS

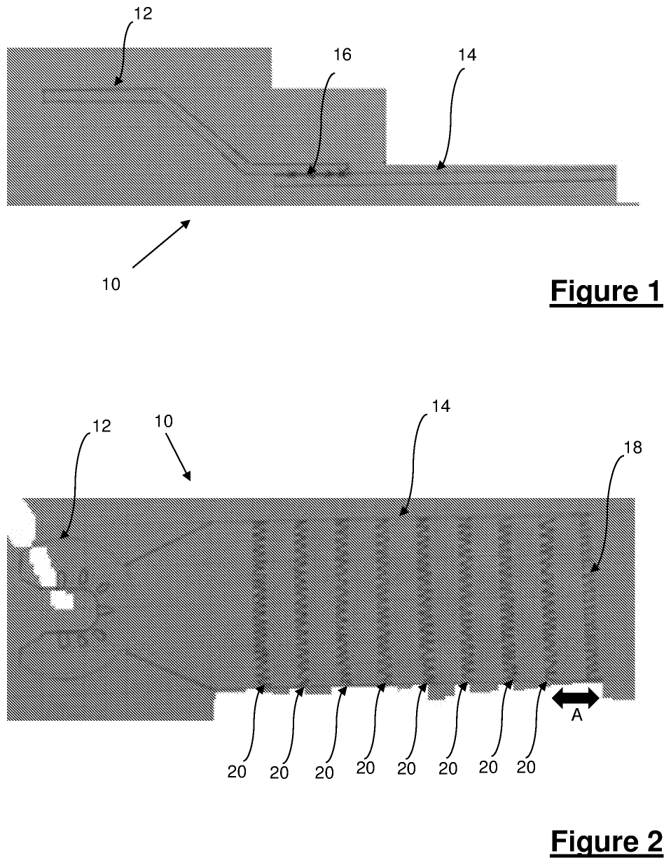

Referring firstly to FIG. 1, a blade for an oscillating tool is indicated generally at 10. The blade 10, like most known multi-tool blades, has an attachment section 12 and a blade section 14. The attachment section 12 is permanently joined to the blade section 14 by spot welds 16, although other ways of joining the sections are possible and in some embodiments the attachment section 12 and blade section may be made from a single continuous piece of material.

In FIG. 2, a forward-facing serrated edge 18 is shown. The length of the blade is considered to be the length form the front edge 18 all the way back to the attachment section 12. The width of the blade is in the orthogonal direction, i.e. along the front edge 18 of the blade. Accordingly the serrated front edge 18 extends all the way from one lateral side of the blade to the other lateral side.

FIG. 2 shows eight lines of cutouts 20. The lines 20 are shown schematically, and other drawings should be referred to for the arrangement of cutouts and spaces along each line. However, it will be apparent from FIG. 2 that once the serrated front edge 18 is blunt/worn, the part of the blade section marked ‘A’ can be snapped off along the next line 20 back from the front edge 18. This will reveal a new serrated edge which can be used to continue cutting.

By providing a tool having a slit which is slightly less than the length A between lines 20, the front part of the blade section can be reliably snapped off along the next line back at each stage. In this example, this can be done eight times to reveal a new, sharp, serrated edge, before the blade 10 is finally completely worn out and has to be discarded.

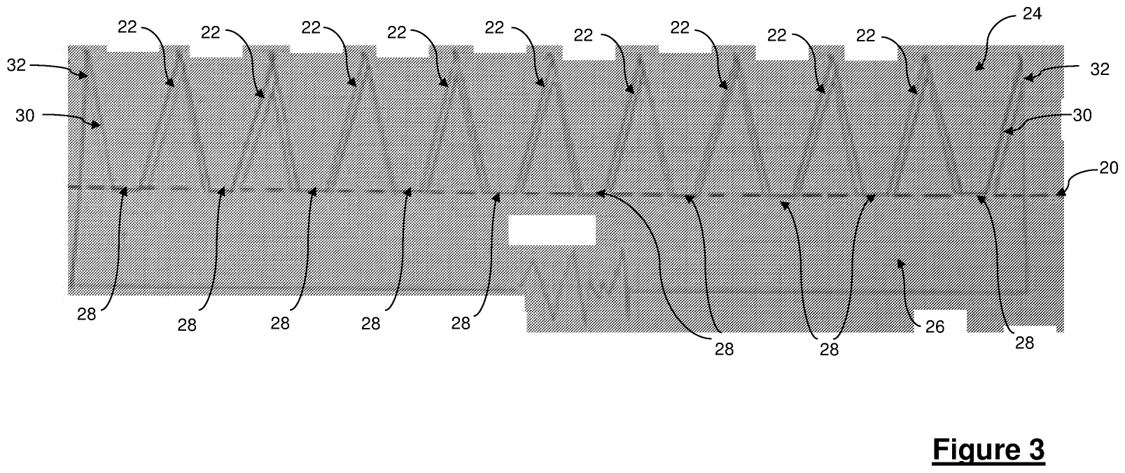

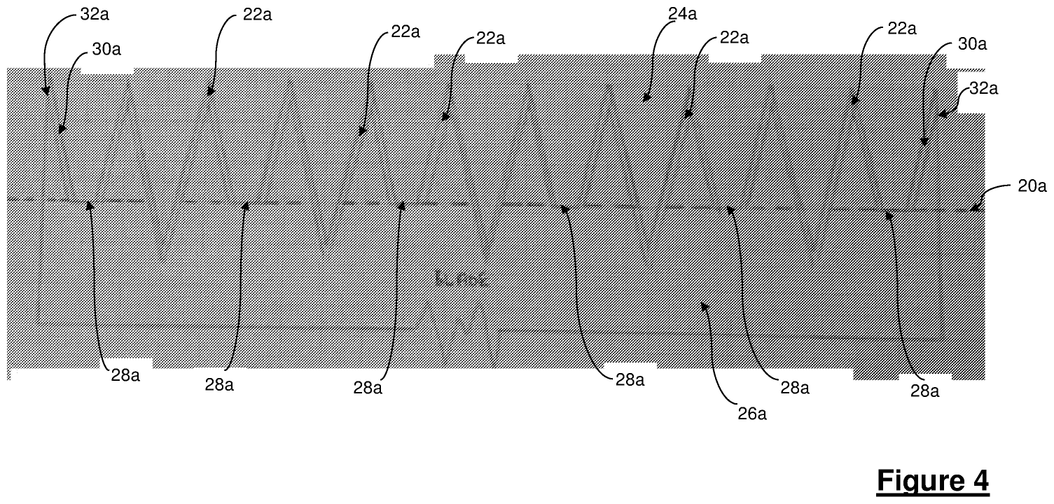

FIG. 3 shows more detail of the line 20 of cutouts. It will be seen that each of the eight lines 20 shown in FIG. 2 may be identical, and according to the detail shown in FIG. 3. The part of the blade 10 in front of the line is referred to as the “front part”24 and the part behind the line 20 is referred to as the “rear part” 26. When a section is snapped off, there will be a new front edge and hence a new designated front part and rear part.

In this embodiment, nine V-shaped cutouts 22 are shown, in a line, with the point of the V in each case facing forwards. The V-shaped cutouts 22 are spaced apart, and the front part 24 is attached to the rear part 26 by material in the spaces 28 between the V-shaped cutouts 22. In this embodiment the cutouts are through cutouts. In other words material has been completely removed to create a small gap between the front part 24 and the rear part 26, at the cutouts. The front part 24 and the rear part 26 are only connected by material in the spaces 28 between the cutouts.

Note that at each extreme lateral edge, a cutout 30 extends all the way to the edge to form a point 32 at each edge. This means that when the front part is removed to reveal a new serrated edge, the new serrated edge will be able to cut all the way along its width. This can be important for fine detailed cutting work for which oscillating tools are often used.

FIG. 4 shows an alternative pattern of a line 20a of cutouts, which forms an alternative serrated edge when the front part 24a is snapped off from the rearward part 26a. In FIG. 4, five W-shaped cutouts 22a are shown, two points of each W-shaped cutout facing forwards and the central point of the W-shaped cutout facing rearward. In this example, the rearward point extends behind the line 20a which joins adjacent W-shaped cutouts at the rearward extend of their lateral sides.

Each W-shaped cutout 22a could of course be considered as two V-shaped cutouts which run into each other.

The W-shaped cutouts 22a are spaced apart from each other along the width of the blade. In the spaces 28a between cutouts 22a, the front part 24a is joined to the rear part 26a by continuous material (i.e. there is no cutout and so the parts are joined). It is these parts 28a which will break, along the line 20a, when the front part 24a is snapped off the rear part 26a.

Just the same as the embodiment of FIG. 3, at each extreme lateral edge, a cutout 30a extends all the way to the edge to form a point 32a at each edge. This means that when the front part is removed to reveal a new serrated edge, the new serrated edge will be able to cut all the way along its width.

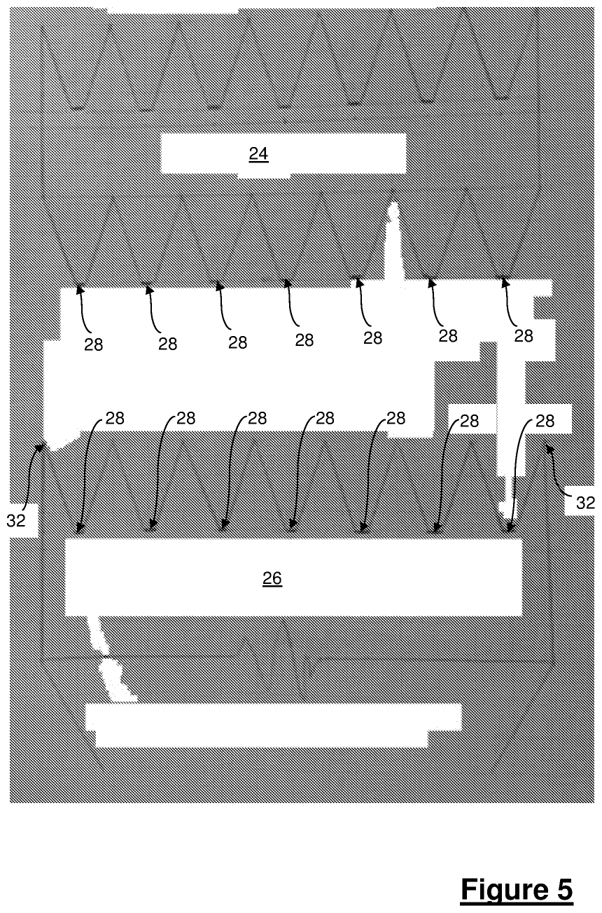

FIG. 5 shows the same parts as FIG. 3, but when the front part 24 has been detached from the rear part 26 to reveal a new serrated cutting edge. Note that the spaces 28 between the cutouts, i.e. parts which in FIG. 3 were joined together, indeed there was continuous material joining the front and rear parts 24, 26, have snapped so that the front part 24 is detached from the rear part 26.

The word “substantially” as used herein is intended to acknowledge that some imperfections and variations are inherent in design and manufacturing, and that some equivalent embodiments may make slight variations from the ideal without departing substantially from the concepts set forth herein. A “substantially forward-facing point”, for example, may deviate slightly from perfectly forward-facing by a few degrees, generally on the order of 15 degrees or so. Similarly, “substantially V-shaped” or “substantially W-shaped” may permit slight distortions or variations from exact shapes while retaining the substance otherwise set forth herein.

The embodiments described above are provided by way of example only, and various changes and modifications will be apparent to persons skilled in the art without departing from the scope of the present invention as defined by the appended claims and their legal equivalents.

What is claimed is:

1. A blade assembly for an oscillating tool, the blade assembly comprising:
an attachment section having an attachment formation for mating with an oscillating tool; and
a blade section, the blade section having a serrated front edge in which at least one line of cutouts is provided along the width of the blade section behind the serrated front edge, each cutout defining at least one substantially forward-facing point, and in which the cutouts are spaced apart along the width of the blade section, a front part of the blade section forward of the cutouts being attached to a rear part of the blade section behind the cutouts at least by material in the spaces laterally between the cutouts.

2. A blade assembly as claimed in claim 1 in which one of the cutouts extends to a forward-facing point at a lateral edge of the blade section.

3. A blade assembly as claimed in claim 2 in which another cutout extends to a forward-facing point at another lateral edge of the blade section.

4. A blade assembly as claimed in claim 1 in which at least one of the cutouts is substantially V-shaped, with the point of the V facing forwards.

5. A blade assembly as claimed in claim 1 in which at least one of the cutouts is substantially W-shaped, with two points facing forward and one point facing backwards.

6. A blade assembly as claimed in claim 1 in which the cutouts are through cutouts, whereby the blade section is cut all the way through the material.

7. A blade assembly as claimed in claim 1 in which the cutouts are partial cutouts, whereby the blade section is thinned.

8. A blade assembly as claimed in claim 1 in which the blade section is made from carbide steel.

9. A blade assembly as claimed in claim 1 in which the cutouts are bevelled.

10. A blade assembly as claimed in claim 1 in which a plurality of lines of cutouts are provided, the lines being spaced along the length of the blade section.

11. A system comprising:
a blade assembly comprising:
an attachment section having an attachment formation for mating with an oscillating tool; and
a blade section, the blade section having a serrated front edge in which at least one line of cutouts is provided along the width of the blade section behind the serrated front edge, each cutout defining at least one substantially forward-facing point, and in which the cutouts are spaced apart along the width of the blade section, a front part of the blade section forward of the cutouts being attached to a rear part of the blade section behind the cutouts at least by material in the spaces laterally between the cutouts; and
a tool for snapping-off a front part of the blade section, the tool comprising a body having a slit for receiving the front part of the blade section.

12. A system of claim 11 in which one of the cutouts of the blade assembly extends to a forward-facing point at a lateral edge of the blade section.

13. A system of claim 12 in which another cutout of the blade assembly extends to a forward-facing point at another lateral edge of the blade section.

14. A system of claim 11 in which at least one of the cutouts of the blade assembly is substantially V-shaped, with the point of the V facing forwards.

15. A system of claim 11 in which at least one of the cutouts of the blade assembly is substantially W-shaped, with two points facing forward and one point facing backwards.
